(19) United States
(12) Patent Application Publication
(10) Pub. No.: US 2026/0164479 A1
(43) Pub. Date: Jun. 11, 2026

(54) ESTABLISHING A MULTIPATH UNICAST LINK

(71) Applicant: Lenovo (Singapore) Pte. Ltd., New Tech Park (SG)

(72) Inventors: Dimitrios Karampatsis, Ruislip (GB); Joachim Löhr, Wiesbaden (DE); Prateek Basu Mallick, Dreieich (DE); Karthikeyan Ganesan, Kronberg im Taunus (DE)

(21) Appl. No.: 18/706,688

(22) PCT Filed: Dec. 2, 2021
(86) PCT No.: PCT/EP2021/084078

§ 371 Date: May 1, 2024

(30) Foreign Application Priority Data
Nov. 1, 2021 (GR) 20210100760

(51) Int. Cl. H04W 76/14; H04L 45/24; H04W 92/18

(52) U.S. Cl. CPC H04W 76/14; H04L 45/24; H04W 92/18

(57) ABSTRACT

Apparatuses, methods, and systems are disclosed for establishing a multipath unicast link. One apparatus includes a processor and a transceiver that receives a first request from a first path for establishing a sidelink unicast connection and receives a second request from a second path for establishing the sidelink unicast connection, where the first request and second request each include a first identifier of a first requestor. The processor determines that a multipath unicast link is allowed to be established via the first and second paths and allocates a link identifier for the multipath unicast link. The processor establishes a plurality of physical radio bearers and associates each physical bearer with the link identifier, where each bearer corresponds to a path of the multipath unicast link.

### FIELD

The subject matter disclosed herein relates generally to wireless communications and more particularly relates to establishing a unicast link for sidelink communication over multiple paths.

### BACKGROUND

In sidelink communication, a User Equipment (“UE”) is able to communicate directly with another UE and without relaying its messages via a wireless network.

### BRIEF SUMMARY

Disclosed are procedures for establishing a multipath unicast link. Said procedures may be implemented by apparatus, systems, methods, or computer program products.

One method of a sidelink User Equipment (“UE”) for establishing a multipath unicast link includes receiving a first request from a first path for establishing a sidelink unicast connection and receiving a second request from a second path for establishing a sidelink unicast connection. Here, the first request includes a first identifier of a first requestor, and the second request also includes the first identifier. The first method includes determining that a multipath unicast connection is allowed to be established via both the first path and the second path and allocating a first link identifier for the multipath unicast connection. The first method includes establishing a plurality of physical radio bearers and associating each physical bearer with the first link identifier. Here, each bearer corresponds to a path of the multipath unicast connection and each bearer is associated with a bearer identifier.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for establishing a multipath unicast link;

FIG. 2 is a diagram illustrating one embodiment of a sidelink relay arrangement;

FIG. 3 is a diagram illustrating one embodiment of a procedure for establishing a single-path unicast connection;

FIG. 4 is a diagram illustrating one embodiment of a procedure for establishing a single-path unicast connection via a UE-to-UE relay;

FIG. 5A is a block diagram illustrating one embodiment of a PC5 protocol stack for a sidelink interface;

FIG. 5B is a block diagram illustrating one embodiment of a PC5 protocol stack for a sidelink interface via a relay UE;

FIG. 6A is a diagram illustrating one embodiment of a method for establishing a multipath unicast link;

FIG. 6B is a continuation of the procedure of FIG. 6A;

FIG. 6C is a continuation of the procedure of FIGS. 6A and 6B;

FIG. 7 is a diagram illustrating one embodiment of a multipath unicast link;

FIG. 8A is a diagram illustrating another embodiment of a method for establishing a multipath unicast link;

FIG. 8B is a continuation of the procedure of FIG. 8A;

FIG. 8C is a continuation of the procedure of FIGS. 8A and 8B;

FIG. 9 is a diagram illustrating another embodiment of a multipath unicast link;

FIG. 10 is a block diagram illustrating one embodiment of a user equipment apparatus that may be used for establishing a multipath unicast link;

FIG. 11 is a block diagram illustrating one embodiment of a network apparatus that may be used for establishing a multipath unicast link; and

FIG. 12 is a flowchart diagram illustrating one embodiment of a first method for establishing a multipath unicast link.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for establishing a multipath unicast link. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

As of 3GPP NR Release 17 (“Rel-17”) two UEs establish a sidelink connection either directly or via a relay, but current specifications allow for sidelink communication only via a single path. However, having a multiple-path (i.e., “multipath”) connection would allow for support of redundant connectivity (duplication of packets in the two paths) and service continuity (when one path is lost UEs immediately switch communication to the second path).

Disclosed herein are solutions for improving sidelink communication among a set of UEs by supporting a multipath unicast link between a source UE and a target UE. At least one path is established via a relay UE, while other paths are established either via different relay UE(s) or directly with the source UE. The procedures described herein disclose how two UEs identify that multiple unicast connectivity requests are associated to the same UEs, and that multipath connectivity can be established. The below descriptions also disclose how a sidelink layer and Access Stratum (“AS”) layers in the UEs establish and maintain a multipath sidelink connection. Here, the sidelink layer may be any layer that handles services requiring sidelink connectivity. For example, the sidelink layer may a layer supporting proximity services, such as a ProSe layer. As another example, the sidelink may be a layer supporting Vehicle-to-Everything (“V2X”) service, such a V2X layer. As used herein the term “ProSe/V2X layer” is used to denote the sidelink layer that supports ProSe services, V2X services, or other services requiring sidelink connectivity. Additionally, the term “ProSe/V2X service” refers to any sidelink service supported by the ProSe/V2X layer.

According to a first solution, the ProSe/V2X layer determines and establishes multipath connection via two independent unicast links. Embodiments of the first solution describe procedures for the ProSe/V2X layer in the UE to identify that multiple unicast link request via different path are associated to the same source UE and establish and maintain two independent unicast link via the identified paths.

According to a second solution, the AS layer maintains redundancy of packets after a multipath connection is established. Embodiments of the second solution describe how the AS layer is to duplicate packets via both paths to support redundant connectivity.

According to a third solution, ProSe/V2X layer determines and establishes multipath connection using split-bearer paradigm. Embodiments of the third solution describe procedure for the ProSe/V2X layer in the UE to identify that multiple unicast link request via different path are associated to the same source UE and establish a split-bearer connection via multiple paths. The ProSe/V2X layer maintain one logical bearer with the same security association which is associated to two Radio Link Control (“RLC”) bearers over the different unicast paths.

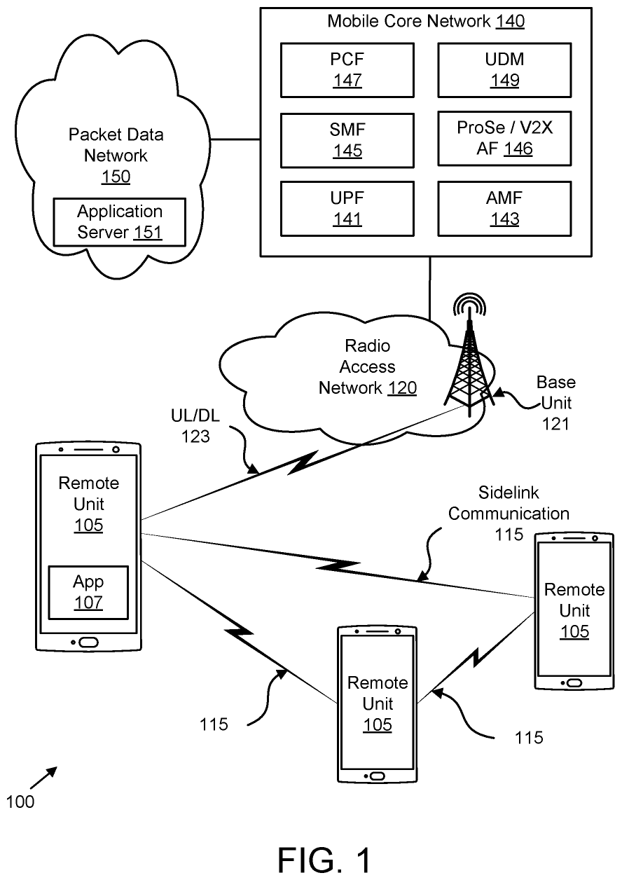

FIG. 1 depicts a wireless communication system 100 for supporting multipath unicast links for wireless devices supporting Sidelink (“SL”) communication 115 (e.g., V2X and/or ProSe services), according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may concurrently have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5G core (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”, also referred to as “Unified Data Repository”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QOS handling, and external PDU session for interconnecting Data Network (“DN”), in the 5G architecture. The AMF 143 is responsible for termination of Non-Access Stratum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The ProSe/V2X Application Function (“AF”) 146 is an application function that supports ProSe/V2X services. In certain embodiments, the ProSe/V2X AF 146 sends configuration information to the remote unit 105 for ProSe/V2X service, including information on configuring a multipath sidelink connection. The PCF 147 is responsible for unified policy framework, providing policy rules to CP functions, access subscription information for policy decisions in UDR. In some embodiments, the PCF 147 includes a ProSe/V2X Function that supports ProSe/V2X services and may send configuration information to the remote unit 105 for configuring a multipath sidelink connection.

The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the Fifth Generation Core network (“5GC”). When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for establishing a multipath unicast link apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In various embodiments, the remote units 105 may communicate directly with each other (e.g., device-to-device communication) using sidelink communication 115. Here, sidelink transmissions may occur on sidelink resources. A remote unit 105 may be provided with different sidelink communication resources according to different allocation modes. Mode-1 corresponds to a NR-based network-scheduled sidelink communication mode, wherein the in-coverage RAN 120 indicates resources for use in sidelink operation, including resources of one or more resource pools. Mode-2 corresponds to a NR-based UE-scheduled sidelink communication mode (i.e., UE-autonomous selection), where the remote unit 105 select a resource pools and resources therein from a set of candidate pools. Mode-3 corresponds to an LTE-based network-scheduled sidelink communication mode. Mode-4 corresponds to an LTE-based UE-scheduled sidelink mode (i.e., UE-autonomous selection).

As used herein, a “resource pool” refers to a set of resources assigned for sidelink operation. A resource pool consists of a set of resource blocks (i.e., Physical Resource Blocks (“PRB”)) over one or more time units (e.g., subframe, slots, Orthogonal Frequency Division Multiplexing (“OFDM”) symbols). In some embodiments, the set of resource blocks comprises contiguous PRBs in the frequency domain. A PRB, as used herein, consists of twelve consecutive subcarriers in the frequency domain. In certain embodiments, a UE may be configured with separate transmission resource pools (“Tx RPs”) and reception resource pools (“Rx RPs”), where the Tx RP of one UE is associated with an Rx RP of another UE to enable sidelink communication.

In various embodiments, the sidelink communication 115 relates to one or more services requiring sidelink connectivity, such as V2X services and ProSe services. A remote unit 105 may establish one or more sidelink connections with nearby remote units 105. A V2X application 107 running on a remote unit 105 may generate data relating to a V2X service and use a sidelink connection to transmit the V2X data to one or more nearby remote units 105. As described in greater detail below, a remote unit 105 may establish a multipath unicast link to support of service continuity (switch communication to a second path when a first path is lost) and/or redundant connectivity (duplication of packets in the two paths).

In the following descriptions, the term “RAN node” is used for the base station/base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for establishing a multipath unicast link.

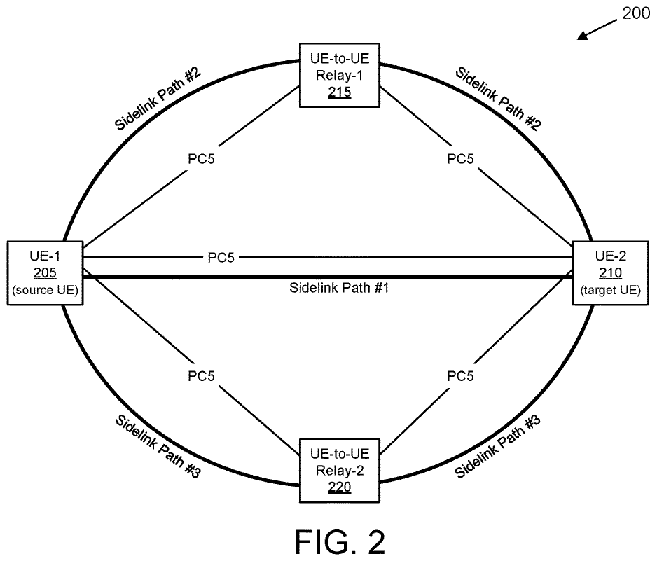

FIG. 2 depicts one embodiment of a sidelink relay arrangement 200, according to embodiments of the disclosure. The source and target UEs may have a direct sidelink connection and/or may establish a sidelink connection via a UE-to-UE relay. The sidelink relay arrangement 200 includes a first UE (denoted as “UE-1”) 205 and a second UE (denoted as “UE-2”) 210. In the depicted embodiments, the UE-1 205 is a source UE and the UE-2 210 is a target UE. The sidelink relay arrangement 200 also includes a first UE-to-UE relay (denoted as “UE-to-UE Relay-1”) 215 and a second UE-to-UE relay (denoted as “UE-to-UE Relay-2”) 220. Each UE may be one embodiment of the remote unit 105.

In the depicted sidelink relay arrangement 200, the UE-1 205 may connect to the UE-2 210 directly, shown as Sidelink Path #1. The UE-1 205 may connect to the UE-2 210 via UE-to-UE Relay-1 215, shown as Sidelink Path #2. The UE-1 205 may connect to the UE-2 210 via UE-to-UE Relay-2 220. In such scenario, the UEs 205 and 210 may establish a multipath sidelink connection using one direct path (i.e., Sidelink Path #1) and one indirect path (via a relay, e.g., Sidelink Path #2 or Sidelink Path #3. Alternatively, the UEs 205 and 210 may establish a multipath sidelink connection using multiple indirect paths (i.e., Sidelink Path #2 and Sidelink Path #3).

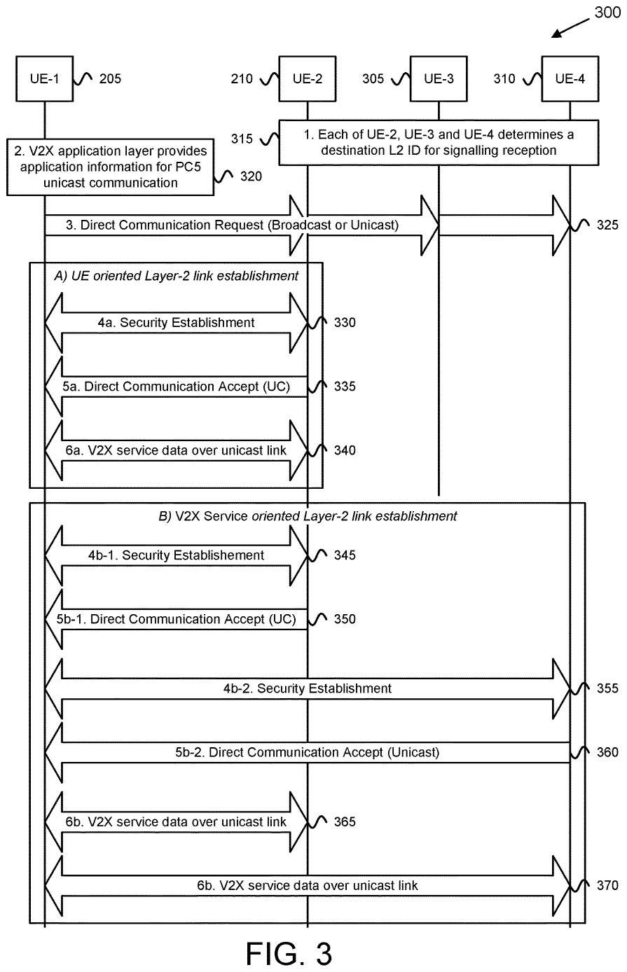

FIG. 3 depicts an embodiment of a procedure 300 for establishing a single-path unicast connection, according to embodiments of the disclosure. The procedure 300 utilizes PC5 Signaling (“PC5-S”) protocol and involves the UE-1 205, the UE-2 210, a third UE (denoted as “UE-3”) 305 and a fourth UE (denoted as “UE-4”) 310. Each UE may be one embodiment of the remote unit 105.

At Step 1, each of the UE-2 210, the UE-3 305 and the UE-4 310 determines (e.g., self-assigns) its destination Layer-2 (“L2”) ID for PC5 signaling reception (see block 315). While not depicted in FIG. 3, the UE-1 205 may also self-assign its source L2 ID for the PC5 unicast link. In various embodiments, the self-assigned L2 IDs may be selected based on an associated service, such as a V2X service type and/or ProSe/V2X service.

In some embodiments, a UE may be configured by the network (i.e., RAN and/or PLMN) with certain destination L2 IDs. For example, a UE may be configured with a mapping of V2X service types (and/or ProSe/V2X services) to default Destination L2 ID(s) for initial signaling to establish unicast connection. Additionally, the UE may be configured with a mapping of V2X service types (and/or ProSe/V2X services) to Destination L2 ID(s) for broadcast and a mapping of V2X service types to Destination L2 ID(s) for groupcast mode communication. Still further, the configuration may map V2X service types (and/or ProSe/V2X services) to the default mode of communication (i.e., broadcast mode, groupcast mode or unicast mode) and/or map V2X service types (and/or ProSe/V2X services) to operational frequencies (e.g., V2X frequencies) with corresponding Geographical Area(s).

At Step 2, having as example sidelink communication for V2X services, the V2X application layer of the UE-1 205 provides application information for PC5 unicast communication (see block 320). The application information may include the V2X service type(s) and the initiating UE Application Layer ID. The target UE's Application Layer ID may also be included in the application information. Accordingly, the upper layers (e.g., V2X layer) at the UE-1 205 initiate a PC5 unicast link establishment. During unicast link establishment procedure, the UE-1 205 sends its source L2 ID for the PC5 unicast link to the peer UE(s), i.e., the UE(s) for which a destination ID has been received from the upper layers.

At Step 3, the UE-1 205 sends a Direct Communication Request (i.e., a PC5-S message), which request includes the Source L2 ID of the UE 1 (see signaling 325). Moreover, the Direct Communication Request contains as Destination L2 ID either the L2 ID of the target UE or a broadcast L2 ID (broadcast L2 ID denotes that UE-1 205 request a unicast connection). In the Direct Communication Request, the application layer information which is provided by the V2X application in UE-1 205 (e.g., information about V2X service type(s) requesting L2 link establishment) is included. The Direct Communication Request may further include information for the establishment of security.

The receiving UEs (i.e., UE-2 210, UE-3 305 and UE-4 310) verify whether the said destination ID belongs to it, if yes decide whether they are interested in establishing a unicast connection with the UE-1 205 (e.g., by interfacing with a local instance of the V2X application). As depicted, there are different options for establishing a L2 link between sidelink UEs. As a first option (denoted as “Option A”), the L2 link establishment is UE oriented. Alternatively, as a second option (denoted as “Option B”), the L2 link establishment is V2X service oriented.

According to Option A, at Step 4a the interested UE(s) exchange security information to establish a secure link and negotiate the QoS. In the depicted embodiment, the UE-2 210 decides to establish a unicast (“UC”) connection, and the UE-1 205 and UE-2 210 establish a security context for the unicast connection (see messaging 330). In one embodiment, the security establishment procedure defined in 3GPP Technical Specification (“TS”) 23.287 is used to enable security protection. In certain embodiments, the UE-1 205 and UE-2 210 may negotiate security parameters for the unicast connection via upper layer messaging.

At Step 5a, the UE-2 210 accepts the Unicast link establishment request by responding with a Direct Communication Accept message (see messaging 335), where the Accept message includes as the Source ID the L2 ID of UE-2 210 (denoted “UE-2 L2 ID”) and includes as the Target L2 ID the L2 ID of the UE-1 205 (denoted “UE-1 L2 ID”). A pair of source L2 ID and destination L2 ID therefore uniquely identifies the unicast link.

At Step 6a, after successful PC5 unicast link establishment, the peer UEs use the same pair of L2 IDs for subsequent V2X service data transmission (see messaging 340). Note that the established PC5 unicast link is bi-directional, therefore the UE-2 210 can send the V2X service data to UE-1 205 over the unicast link with UE-1 205.

According to Option B, at the interested UE(s) exchange security information to establish a secure link and negotiate the QoS. In the depicted embodiment, the UE-2 210 and UE-4 310 decide to establish a unicast (“UC”) connection.

At Step 4b-1, the UE-1 205 and UE-2 210 establish a security context for the unicast connection (see messaging 345). In certain embodiments, the UE-1 205 and UE-2 210 may negotiate security parameters for the unicast connection via upper layer messaging.

At Step 5b-1, the UE-2 210 accepts the Unicast link establishment request by responding with a Direct Communication Accept message (see messaging 350), where the Accept message includes as the Source ID their L2 ID and includes the L2 ID of the UE-1 205 as the Target L2 ID. A pair of source L2 ID and destination L2 ID uniquely identifies the unicast link.

At Step 4b-2, the UE-1 205 and UE-4 310 establish a security context for the unicast connection (see messaging 355). In certain embodiments, the UE-1 205 and UE-4 310 may negotiate security parameters for the unicast connection via upper layer messaging.

At Step 5b-2, the UE-4 310 accepts the Unicast link establishment request by responding with a Direct Communication Accept message (see messaging 360), where the Accept message includes as the Source ID the L2 ID of UE-4 310 and includes the L2 ID of the UE-1 205 as the Target L2 ID. A pair of source L2 ID and destination L2 ID uniquely identifies the unicast link.

At Steps 6b, after successful PC5 unicast link establishment, the peer UEs use the same pair of L2 IDs for subsequent V2X service data transmission (see messaging 365 and 370). Note that the established PC5 unicast link is bi-directional, therefore the peer UEs can send the V2X service data to UE-1 205 over their unicast links with UE-1 205.

While FIG. 3 is described in the context of a V2X service, the same procedure can be used for a ProSe service, e.g., where a ProSe application and/or ProSe layer initiates PC5 unicast link establishment.

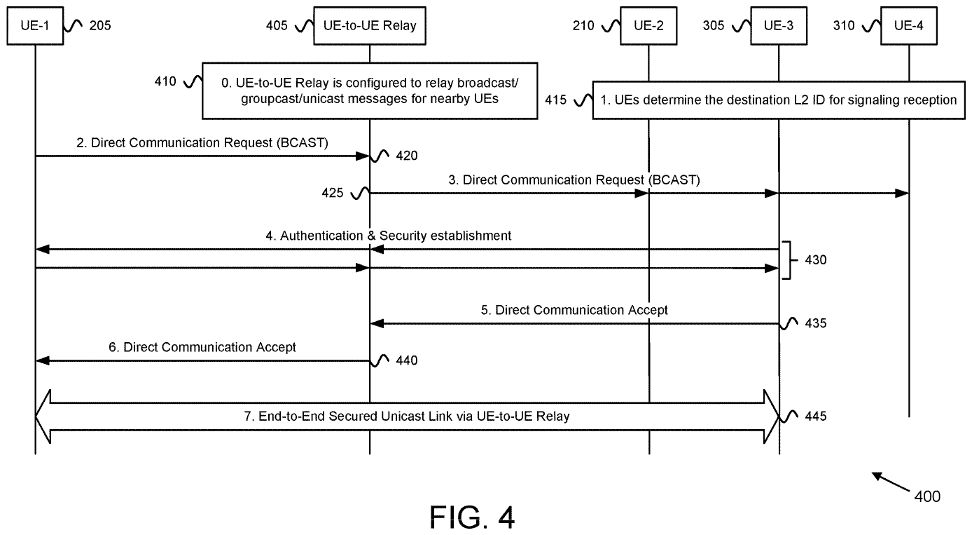

FIG. 4 depicts an embodiment of a procedure 400 for establishing a single-path unicast connection via a UE-to-UE relay, according to embodiments of the disclosure. The procedure 400 utilizes PC5 Signaling (“PC5-S”) protocol and involves the UE-1 205, a UE-to-UE relay 405, the UE-2 210, a third UE (denoted as “UE-3”) 305 and a fourth UE (denoted as “UE-4”) 310. Each UE may be one embodiment of the remote unit 105. In one embodiment, the UE-to-UE relay 405 is one embodiment of the UE-to-UE Relay-1 215 or the UE-to-UE Relay-2 220.

To support a unicast connection via relay, the UE-to-UE Relay 405 overrides the source field of the message with its Relay Layer-2 (“R-L2”) ID and adds its unique relay identifier (“RID”) as a relay indication. This relay indication is added by the UE-to-UE Relay 405 only on broadcast messages since these messages are sent in clear text (i.e., without any encryption or integrity protection) and thus may be modified. The UE-to-UE Relay 405 proceeds in forwarding the broadcast Direct Communication Request message received from the source UE.

At Step 0, as a prerequisite, the UE-to-UE Relay 405 is configured to relay broadcast, or groupcast, or unicast messages (see block 410).

At Step 1, each of the UE-2 210, the UE-3 305 and the UE-4 310 determines (i.e., self-assigns) its destination L2 ID for PC5 signaling reception (see block 415). While not depicted in FIG. 4, the UE-1 205 may also self-assign its source L2 ID for the PC5 unicast link. In various embodiments, the self-assigned L2 IDs may be selected based on an associated service, such as a V2X service type and/or ProSe/V2X service.

The V2X application layer of the UE-1 205 provides application information for PC5 unicast communication. Accordingly, the upper layers (e.g., V2X layer) at the UE-1 205 initiate a PC5 unicast link establishment. During unicast link establishment procedure, the UE-1 205 sends its source L2 ID for the PC5 unicast link to the peer UE(s), i.e., the UE(s) for which a destination ID has been received from the upper layers.

At Step 2, the UE-1 205 broadcasts a Direct Communication Request (i.e., a PC5-S message), which request includes the Source L2 ID of the UE 1 (see signaling 420). Moreover, the Direct Communication Request contains as Destination L2 ID a broadcast L2 ID indicating that UE-1 205 requests a unicast connection. In the request, application layer information is included which is provided by the V2X application in UE-1 205.

At Step 3, the UE-to-UE Relay 405 broadcasts the Direct Communication Request received from the UE 1 (see signaling 425). Moreover, the Direct Communication Request contains as Destination L2 ID the broadcast L2 ID indicating that UE-1 205 requests a unicast connection. Again, the request may include the application layer information provided by the V2X application in UE-1 205.

The receiving UEs (i.e., UE-2 210, UE-3 305 and UE-4 310) verify whether the said destination ID belongs to it, if yes decide whether they are interested in establishing a unicast connection with the UE-1 205 (e.g., by interfacing with a local instance of the V2X application).

At Step 4, the interested UE(s) exchange security information to establish a secure link via the UE-to-UE Relay 405 and negotiate the QoS. In the depicted embodiment, the UE-3 305 decides to establish a unicast (“UC”) connection, and the UE-1 205 and UE-3 305 authenticate and establish a security context for the unicast relay connection (see messaging 430). In certain embodiments, the UE-1 205 and UE-3 305 may negotiate security parameters for the unicast connection via upper layer messaging.

At Step 5, the UE-3 305 accepts the Unicast link establishment request by responding with a Direct Communication Accept message to the UE-to-UE Relay 405 (see messaging 435), where the Accept message includes as the Source ID the L2 ID of UE-3 305 and includes the L2 ID of the UE-1 205 as the Target L2 ID. A pair of source L2 ID and destination L2 ID therefore uniquely identifies the unicast link.

At Step 6, the UE-to-UE Relay 405 forwards the Direct Communication Accept message to the UE-1 205 (see messaging 440).

At Step 7, after successful PC5 unicast link establishment, the peer UEs use the same pair of L2 IDs for subsequent V2X service data transmission (see messaging 445). Note here that the Unicast link established via UE-to-UE Relay 405 is secured End-to-End between the UE-1 205 and UE-3 305.

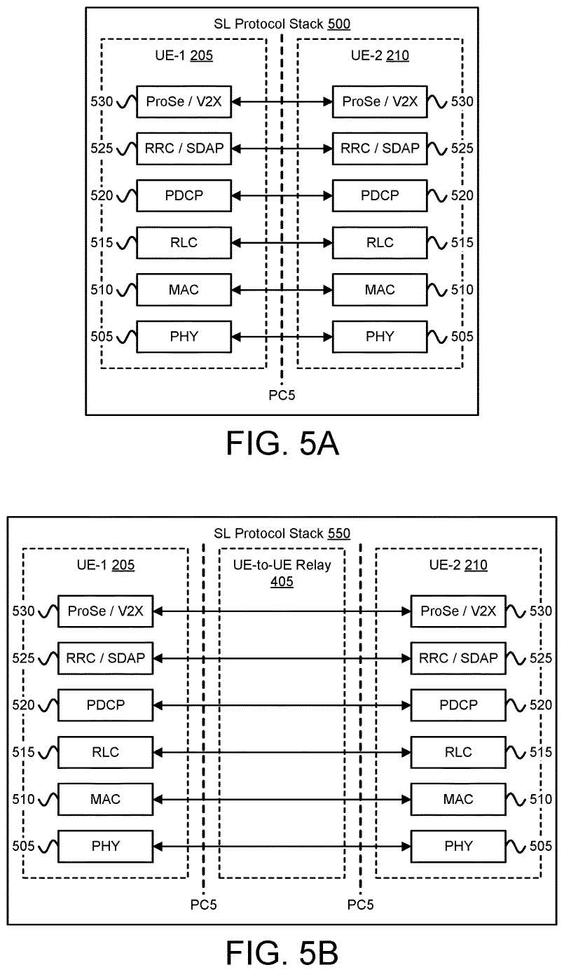

FIG. 5A depicts a PC5 protocol stack 500, according to embodiments of the disclosure. The PC5 protocol stack 500 supports a direct unicast link, for example as established according to the procedure 300. While FIG. 5A shows the UE-1 205 and the UE-2 210, these are representative of a set of UEs communicating peer-to-peer via PC5 and other embodiments may involve different UEs, such a different combination of the UE-1 205, the UE-2 210, the UE-to-UE Relay-1 215, and the UE-to-UE Relay-2 220. As depicted, the PC5 protocol stack includes a physical (“PHY”) layer 505, a Media Access Control (“MAC”) sublayer 510, a Radio Link Control (“RLC”) sublayer 515, a Packet Data Convergence Protocol (“PDCP”) sublayer 520, and Radio Resource Control (“RRC”) and Service Data Adaptation Protocol (“SDAP”) layers (depicted as combined element “RRC/SDAP” 525), for the control plane and user plane, respectively. As depicted, above the RRC/SDAP layer 525 may be the ProSe/V2X layer 530.

The AS protocol stack for the control plane in the PC5 interface consists of at least RRC, PDCP, RLC and MAC sublayers, and the physical layer. The AS protocol stack for the user plane in the PC5 interface consists of at least SDAP, PDCP, RLC and MAC sublayers, and the physical layer. The Layer-1 (“L1”) comprises the PHY layer 505. The Layer-2 (“L2”) is split into the SDAP, PDCP, RLC and MAC sublayers. The Layer-3 (“L3”) includes the RRC sublayer and the NAS layer for the control plane and includes, e.g., an IP layer for the user plane. L1 and L2 are referred to as “lower layers”, while L3 and above (e.g., transport layer, ProSe/V2X layer 530, and application layer(s)) are referred to as “higher layers” or “upper layers.”

FIG. 5B depicts a PC5 protocol stack 550, according to embodiments of the disclosure. The PC5 protocol stack 500 supports a unicast relay link, for example as established according to the procedure 400. While FIG. 5B shows the UE-1 205, the UE-2 210, and the UE-to-UE Relay-1 215, these are representative of a set of UEs communicating peer-to-peer via PC5 and other embodiments may involve different UEs, such as the UE-1 205, the UE-2 210, the UE-to-UE Relay-2 220. As depicted, the PC5 protocol stack includes a PHY layer 505, a MAC layer 510, a RLC layer 515, a PDCP layer 520, and RRC or SDAP layer 525, for the control plane and user plane, respectively. As depicted, above the RRC/SDAP layer 525 may be the ProSe/V2X layer 530.

The AS protocol stack for the control plane in the PC5 interface consists of at least RRC, PDCP, RLC and MAC sublayers, and the physical layer. The AS protocol stack for the user plane in the PC5 interface consists of at least SDAP, PDCP, RLC and MAC sublayers, and the physical layer. Again, the L1 comprises the PHY layer 505. The L2 is split into the SDAP, PDCP, RLC and MAC sublayers. The L3 includes the RRC sublayer and the NAS layer for the control plane and includes, e.g., an IP layer for the user plane.

In some embodiments, the UE-to-UE Relay-1 215 acts as a L3 relay (also referred to as an IP relay). Here, communication between the UE-1 205 (i.e., source UE) and the UE-2 210 (i.e., target UE) via L3 relay goes through two combined PC5 links, i.e., a first PC5 link (corresponding to Interface-1) between the UE-1 205 and the UE-to-UE Relay-1 215 and a second PC5 link (corresponding to Interface-2) between the UE-to-UE Relay-1 215 and the UE-2 210. In such embodiments, the protocol stack of the UE-to-UE Relay-1 215 may include SDAP, RRC, PDCP, RLC, MAC and PHY layers which interact with corresponding layers at the UE-1 205 via the Interface-1, and which also interact with corresponding layers at the UE-2 210 via the Interface-2. As described in further detail below, the UE-to-UE Relay-1 215 may adopt one or more L1 and/or L2 identities of the UE-1 205 to improve communication over sidelink relay interface.

In some embodiments, the UE-to-UE Relay-1 215 acts as a L2 relay. In certain embodiments, the UE-to-UE Relay-1 215 acting as a L2 relay performs relay function below the PDCP layer 520, such that the UE-to-UE Relay-1 215 does not perform PDCP, RRC and SDAP functions for the SL communication. In such embodiments, the protocol stack of the UE-to-UE Relay-1 215 may include RLC layer 515, MAC layer 510 and PHY layer 505 entities which interact with corresponding layers at the UE-1 205 via the Interface-1, and which interact with corresponding layers at the UE-2 210 via the Interface-2. However, for the PDCP layer 520, the RRC and SDAP layers 525, the link endpoints are between the UE-1 205 and the UE-2 210.

In some embodiments, the UE-to-UE Relay-1 215 acts as a L1 relay (also referred to as an Amplify and Forward relay) with Hybrid Automatic Repeat Request (“HARQ”) functionality. In certain embodiments, the protocol stack of the UE-to-UE Relay-1 215 may have PHY layer 505 and a HARQ entity (i.e., of the MAC layer 510) which interact with corresponding layers at the UE-1 205 via the Interface-1, and which interact with corresponding layers at the UE-2 210 via the Interface-2. However, for the remaining layers, the link endpoints are between the UE-1 205 and the UE-2 210.

Note that the above relay descriptions are exemplary, and the UE-to-UE Relay-1 215 is not limited to the above-described relay implementations. Thus, the UE-to-UE Relay-1 215 may implement different protocol stacks and/or link endpoints than those described above, according to the below described solutions.

As described in greater detail below, a target UE may receive a direct communication request via multiple Relay UEs (or both directly from the source UE and via at least one Relay UE). In such a case, the target UE may determine to establish a multipath connection. Beneficially, having a multipath connection allows for support of redundant connectivity where packets are duplicated via both paths allowing applications in the UEs to exchange packet with high reliability. Additionally, having a multipath connection allows for support of service continuity, i.e., when one path is lost the peer UEs can immediately switch communication to the second path and allow the applications in the UEs to exchange packet with no interruption.

A UE may determine that multipath connection should be established (or is required) based on a request from the application layer and/or on configuration information received from the network (e.g., PCF 147) or an Application Function 146. Here, the configuration information may include one or more of:
A multipath indicator per service type (V2X service type or ProSe/V2X service)
A multipath indicator per PC5 QoS Indicator (“PQI,” corresponds to QoS for NR V2X communication), i.e., for a specific PQI a multipath connection is required
An indication that the reliability required (from the corresponding PQI) is higher than a certain threshold, e.g., like five ‘9s’ or more

Once the UEs determine that a multipath connection is required, the below described procedures may be used to establish a multipath unicast link between the source UE (e.g., UE-1 205) and the destination UE (e.g., UE-2 210).

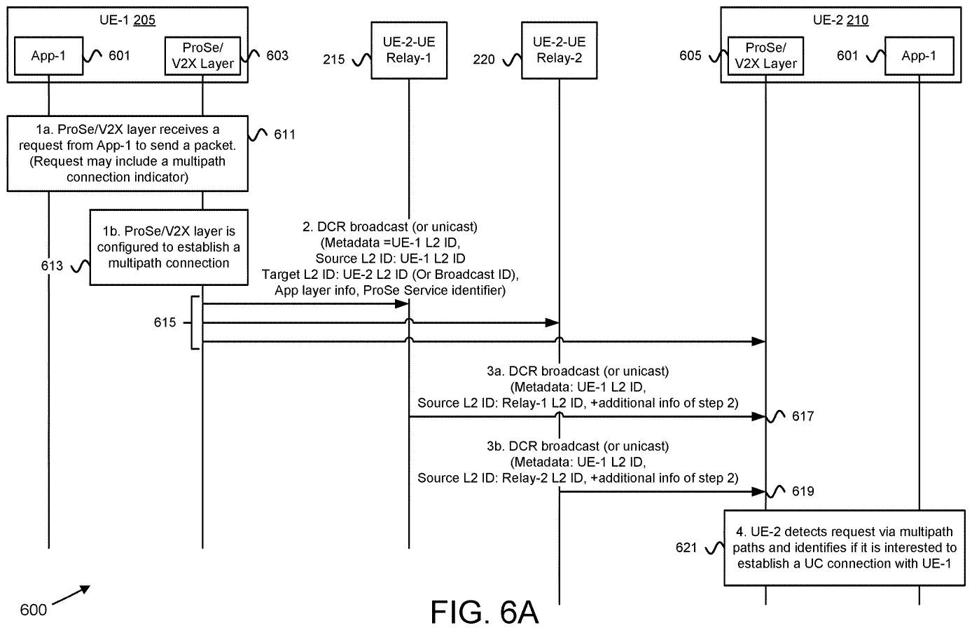

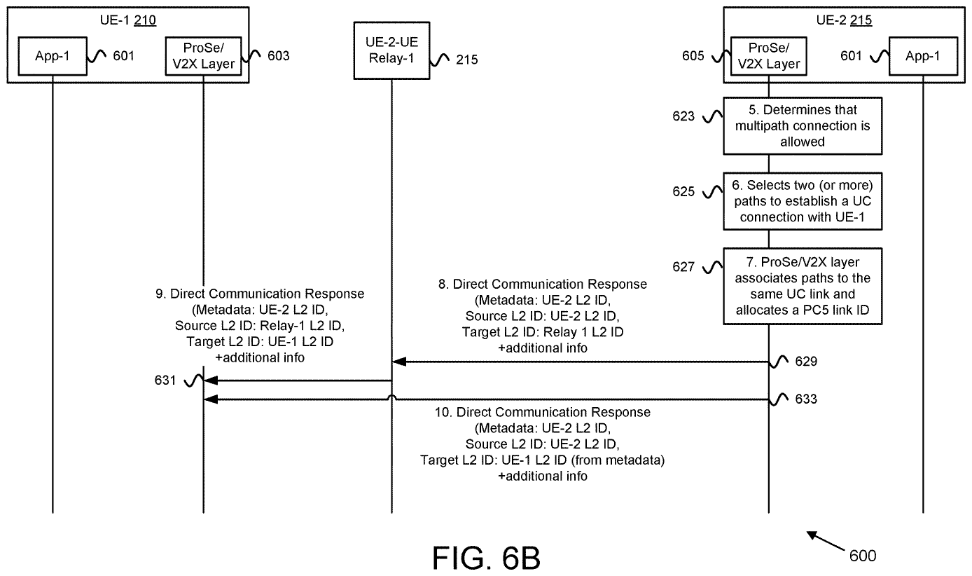

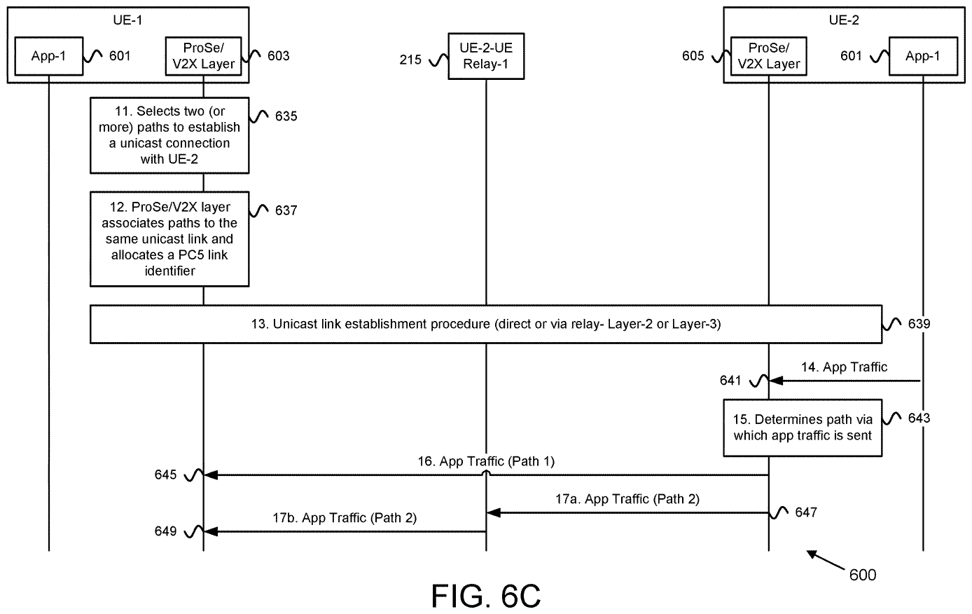

FIGS. 6A-6C depict an example of a first procedure 600 for establishing a multipath unicast connection, according to embodiments of the first solution. The procedure 600 involves the UE-1 205 containing a first application (denoted as “App-1”) 601 and a ProSe/V2X layer 603, the UE-to-UE Relay-1 215, the UE-to-UE Relay-2, and the UE-2 210 containing a ProSe/V2X Layer 605 and another instance of the App-1 601. Each UE may be one embodiment of the remote unit 105. The ProSe/V2X layers 603 and 605 may be embodiments of the ProSe/V2X layer 530.

Beginning at FIG. 6A, at Step 1a the ProSe/V2X layer 603 receives a request from the App-1 601 to send a SL data packet (see block 611). In certain embodiments, the App-1 601 may include a multipath connection indicator in the request sent to the ProSe/V2X layer 603.

At Step 1b, the ProSe/V2X layer 603 at UE-1 205 determines that a multipath connection required, e.g., based on configuration information/or information from higher layers (see block 613).

At Step 2, the UE-1 205 sends a Direct Communication Request message (see messaging 615). As depicted, the Direct Communication Request message is sent directly to UE-2 210 (i.e., Sidelink Path #1) and is relayed by one or more UE-to-UE Relays 215, 220 (e.g., Sidelink Paths #2 and #3). In one embodiment, the Direct Communication Request message is sent in unicast when UE-1 205 knows the identity of UE-2 210. Alternatively, the Direct Communication Request message may be sent in broadcast to a known destination L2 ID, based on configuration.

The UE-1 205 includes in the request additional application layer information (denoted “App layer info”) and a ProSe/V2X identifier, e.g., as described in 3GPP TS 23.304, or a V2X service type, e.g., as described in 3GPP TS 23.287. Based on the multipath requirement determined in Step 1, the UE-1 205 also includes as metadata the L2 identity of UE-1 205 (or another identifier to identify the multipath connection).

At Step 3a, the UE-to-UE Relay-1 215 relays the Direct Communication Request message (if received) to the UE-2 210 (see messaging 617). Here, the UE-to-UE Relay-1 215 includes its own L2 identifier as source L2 ID in the forwarded Direct Communication Request message.

At Step 3b, the UE-to-UE Relay-2 relays the Direct Communication Request message (if received) to the UE-2 210 (see messaging 619). Here, the UE-to-UE Relay-2 includes its own L2 identifier as source L2 ID in the forwarded Direct Communication Request message.

At Step 4, the UE-2 210 determines that it has received multiple Direct Communication Request messages (i.e., via multiple paths) and determines if it interested to establish a unicast link (see block 621). The UE-2 210 identifies (i.e., by inspecting the metadata information) that the multiple Direct Communication Request messages are sent from the same UE (i.e., UE-1 205) and contains the same information.

Continuing on FIG. 6B, at Step 5, based on configuration the UE-2 210 determines that a multipath connection can be established (see block 623).

At Step 6, the UE-2 210 selects the paths to establish a unicast multipath connection (see block 625). In certain embodiments, the selection is based on UE implementation, e.g., based on configuration received from PLMN/MNO. Note that in the case that the UE-2 210 receives Direct Communication Request messages directly and via one or more relay UEs, then the UE-2 210 may then select a subset of paths (e.g., two paths) to establish a multipath connection. Alternatively, multipath connection may be established via all paths.

At Step 7, the ProSe/V2X layer 605 associates the selected paths to the same unicast link and allocates a PC5 link identifier (see block 627). Here, the UE-2 210 locally stores information on how the two paths are associated to the same unicast link. In various embodiments, on the ProSe/V2X layer 605 a unicast link is identified by a PC5 link identifier which is associated with a unicast link profile which includes:
An Application Layer ID and Layer-2 ID of UE-1 205; and
An Application Layer ID and Layer-2 ID of UE-2 210; and
A network layer protocol used on the PC5 unicast link; and
Information about PC5 QOS Flow(s)

In some embodiments, to support a multipath unicast link, one or more of the following may be included within the unicast link profile:
An optional Multipath Link ID
Information on a first link/path of the multipath unicast link (denotes “Link 1”), including:
   Application Layer ID of UE 1 and Layer-2 ID of UE-to-UE Relay-1 215 (assuming that Link 1 is a path sent via a UE-to-UE relay; otherwise, a Layer-2 ID of the source UE); and
   Application Layer ID and Layer-2 ID of UE-2 210; and
   A network layer protocol used on the PC5 unicast link; and
   Information about PC5 QoS Flow(s) for the Link 1
Information on a second link/path of the multipath unicast link (denotes “Link 2”), including:
   Application Layer ID and Layer-2 ID of UE-1 205 (assuming that Link 2 is a direct path to the source UE; otherwise, a Layer-2 ID of the UE-to-UE relay); and
   Application Layer ID and Layer-2 ID of UE-2 210; and
   A network layer protocol used on the PC5 unicast link; and
   Information about PC5 QoS Flow(s) for the Link 2

In an alternative embodiment, the ProSe/V2X layer 605 may allocate separate PC5 link identifiers for each path and associated unicast link profile for each PC5 link identifier. Here, the ProSe/V2X layer 605 maintains an association of the two PC5 link identifiers as a single unicast link. In certain embodiments, the ProSe/V2X layer 605 may assign a multipath link identifier and associate the multipath link identifier to the two PC5 link identifier from each path.

The ProSe/V2X layer 605 may also maintain a mapping of each link to an application socket. For example:
Socket 1=Multipath Link ID+PC5 Link Identifier+UE Relay-1 L2 ID+UE-2 L2 ID
Socket 2=Multipath Link ID+PC5 Link Identifier+UE-1 L2 ID+UE-2 L2 ID

At Step 8, the UE-2 210 responds to the unicast requests by sending a Direct Communication Response message via a Relay UE (see messaging 629), where the Direct Communication Response message includes the UE-2 L2 ID as source L2 ID, additional App layer info, and a ProSe/V2X identifier (e.g., as described in 3GPP TS 23.304) or a V2X service type (e.g., as described in 3GPP TS 23.287). The UE-2 210 includes as destination L2 ID the destination endpoint based on the path selected (i.e., UE Relay-1 L2 ID for Sidelink Path #2, or UE Relay-2 L2 ID for Sidelink Path #3). Based on the multipath requirement, the UE-2 210 also includes as metadata the L2 identity of the UE-2 210 (or another identifier to identify the multipath connection).

At Step 9, the UE-to-UE Relay-1 215 forwards the Direct Communication Response message to the UE-1 205 (see messaging 631)

At Step 10, the UE-2 210 responds to the unicast requests by sending a Direct Communication Response message directly to the UE-1 205 (i.e., via Sidelink Path #1) (see messaging 633), where the Direct Communication Response message includes the UE-2 L 2 ID as source L2 ID, additional App layer info, and a ProSe/V2X identifier (e.g., as described in 3GPP TS 23.304) or a V2X service type (e.g., as described in 3GPP TS 23.287). The UE-2 210 includes as destination L2 ID the destination endpoint based on the path selected (i.e., UE-1 L2 ID for Sidelink Path #1).

Continuing on FIG. 6C, at Step 11, the UE-1 205 selects the paths to establish the unicast multipath connection (see block 635). In certain embodiments, the selection is based on UE implementation, e.g., based on configuration received from PLMN/MNO. Note that in the case that the UE-1 205 receives Direct Communication Response messages directly and via one or more relay UEs, then the UE-1 205 may then select a subset of paths (e.g., two paths) to establish a multipath connection. Alternatively, multipath connection may be established via all paths over which a Direct Communication Response message was received.

At Step 12, the ProSe/V2X layer 603 associates the selected paths to the same unicast link and allocates a PC5 link identifier (see block 637). Here, the UE-1 205 locally stores information on how the two paths are associated to the same unicast link. In various embodiments, on the ProSe/V2X layer 603 a unicast link is identified by a PC5 link identifier which is associated with a unicast link profile which includes:
An Application Layer ID and Layer-2 ID of UE A; and
An Application Layer ID and Layer-2 ID of UE B; and
A network layer protocol used on the PC5 unicast link; and
Information about PC5 QoS Flow(s)

As discussed above, to support a multipath unicast link, the unicast link profile may additionally include:
An optional Multipath Link ID; and/or
Information on Link 1 (described above); and
Information on Link 2 (described above)

At Step 13, the UE-1 205 establishes the unicast link connection via multiple paths (see block 639). For each Path/Link of the multipath unicast link, a security context may be established as described above with reference to FIGS. 3 and 4, and/or as described in 3GPP TS 23.287 and 3GPP TS 23.304.

At Step 14, the ProSe/V2X layer 605 receives application traffic (i.e., one or more packets) from the App-1 601 (see messaging 641).

At Step 15, the ProSe/V2X layer 605 determines how to route the packet(s) (i.e., which path to use) as described in greater detail below (see block 643).

At Step 16, based on the selected multipath routing scheme, the UE-2 210 may send the application traffic (i.e., one or more packets) directly to the UE-1 205 via Sidelink Path #1 (see messaging 645).

At Step 17a, based on the selected multipath routing scheme, the UE-2 210 may send the application traffic (i.e., one or more packets) to the UE-to-UE Relay-1 215 via Sidelink Path #2 (see messaging 647).

At Step 17b, the UE-to-UE Relay-1 215 forwards the application traffic to the UE-1 205 via Sidelink Path #2 (see messaging 649).

The ProSe/V2X layers 603, 605 are configured how to route a packet via the multipath sidelink radio bearers (i.e., active/standby scheme, duplicate the packets, maintain service continuity). In certain embodiments, the configuration information may be sent via the PCF 147 (e.g., via a ProSe/V2X Function within the PCF), or an AF 146 supporting ProSe/V2X function.

In an alternative embodiment, the application 601 may provide indication via which path to send a packet or the ProSe/V2X layer 603, 605 may establish multiple sockets with an application each socket associated with a specific path. In such embodiments, the application layer determines how to route the pa packet via the multipath sidelink radio bearers (i.e., active/standby scheme, duplicate the packets, maintain service continuity). In case of packet duplication, the receiving application 601 will be responsible to resolve (e.g., ignore and/or remove) duplicate packets.

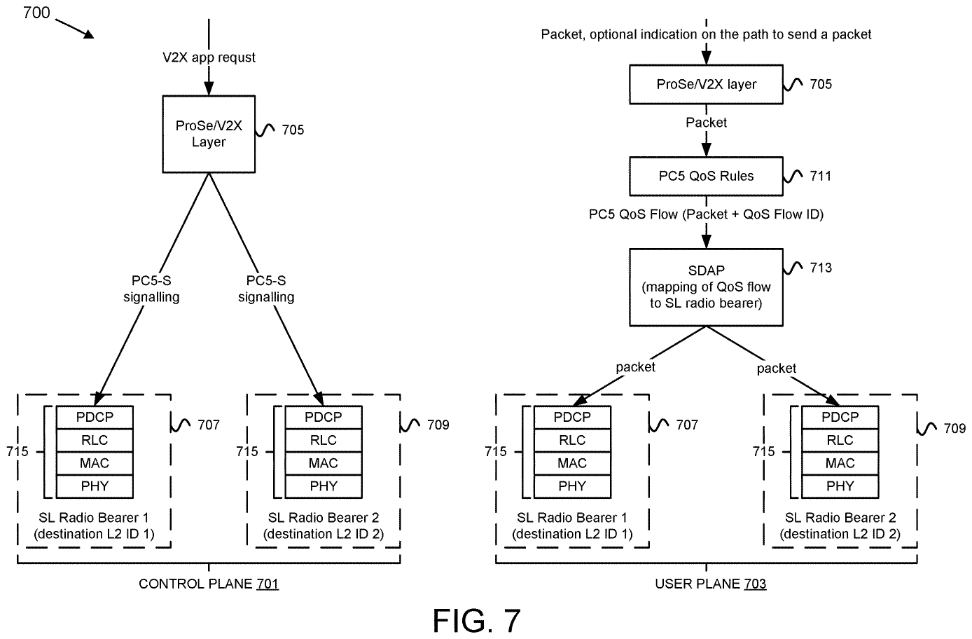

FIG. 7 depicts an example of a multipath unicast link 700, according to embodiments of the first solution, where a ProSe/V2X layer 705 maintains an association of a unicast link to two (or more) sidelink radio bearers (e.g., for control plane 701 and user plane 703). The ProSe/V2X layer 705 may be one embodiment of the ProSe/V2X layer 530, the ProSe/V2X layer 603 and/or the ProSe/V2X layer 605. The multipath unicast link 700 may be established according to the procedure 600, described above.

It is assumed that a UE has one logical unicast link that contains two independent unicast link connections via different paths. That is, each UE has independent security association via each unicast path. At the control plane 701, the ProSe/V2X layer 705 receives a request from a V2X Application and sends PC5-S signaling to a first sidelink radio bearer (denoted “SL Radio Bearer-1”) 707 and/or to a second sidelink radio bearer (denoted “SL Radio Bearer-2”) 709. Note that the SL Radio Bearer-1 707 corresponds to a first destination L2 ID, while the SL Radio Bearer-2 709 corresponds to a second destination L2 ID.

At the user plane 703, the ProSe/V2X layer 705 receives a data packet, which may optionally include an indication on which path the packet is to be sent. The ProSe/V2X layer 705 applies PC5 QoS rules 711 to the packet and maps the packet to a PC5 QoS Flow. The ProSe/V2X layer 705 passes the packet and associated QoS Flow ID to the SDAP layer 713. Note the SDAP layer 713 may be an embodiment of the RRC/SDAP layers 525.

The SDAP layer 713 maps the QoS Flow to a SL Radio Bearer and sends the packet to the mapped SL Radio Bearer. Where the packet is to be duplicated, the packet duplication may occur at the ProSe/V2X layer 705.

In one embodiment, an Adaptation Layer function may be located between the ProSe/V2X layer 705 and the AS layer 715 (i.e., PDCP, RLC, MAC and PHY layers) to manage the relation between the logical unicast connection and the associated unicast links via the different paths.

In some embodiment, ProSe/V2X layer 705 may signal the active and dormant PC5 links to the RAN. Based on the received information, the RAN may suspend the bearer of the dormant PC5 link, i.e., no Radio Link Management (“RLM”) is performed in the dormant PC5 link, and when indicated by ProSe/V2X layer 705 to switch from the dormant to the active PC5 link to the RAN layer, then the RAN may re-establish the bearer accordingly.

According to embodiments of the second solution, a UE may receive configuration information from the network (e.g., from PCF 147) or an Application Function, which configuration indicates whether a redundant unicast connection is required. Accordingly, when a multipath connection is established (as described above with reference to FIGS. 6A-6C) and the ProSe/V2X layer receives data to transmit via the multipath connection, the ProSe/V2X layer duplicates the data and transmits the data via all paths of the multipath connection.

In various embodiments, the ProSe/V2X layer includes a sequence number in the data transmitted to assist the receiving UE (“Rx UE”) in resolving (e.g., ignoring/removing) the received duplicated packets. At the Rx UE, the ProSe/V2X layer discards the duplicate data by identifying packets containing the same sequence number.

In another embodiment, as part of the resource optimization, after establishing multiple PC5 link to the remote UE via different relay UEs (and/or via a direct path the to peer UE), the V2X layer of the transmitting UE (“Tx UE”) may indicate a group destination L2 ID so that the Tx UE can perform groupcast transmission to those relay UEs, which may save some resources instead of duplicating the same packet to those two relay UEs.

According to embodiments of the third solution, multipath sidelink connectivity is handled at the AS layer. In certain embodiments, the third solution is supported for L2 UE and L2 UE relays only.

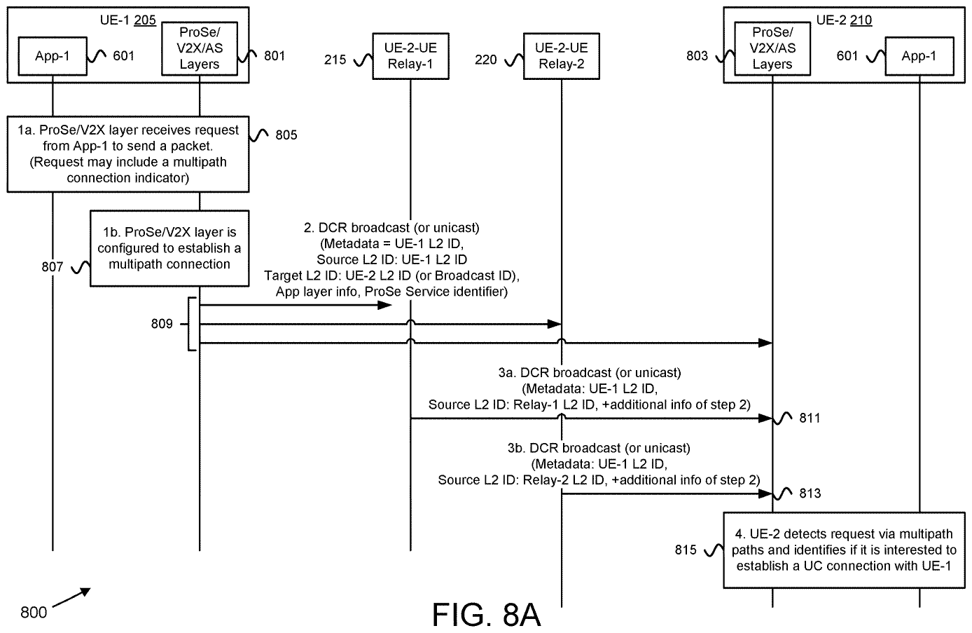

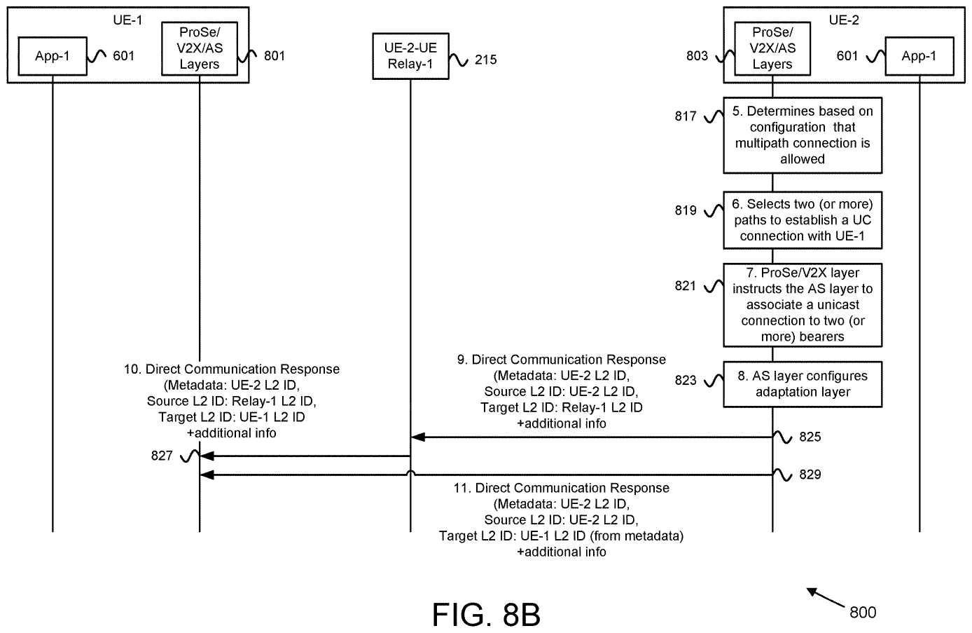

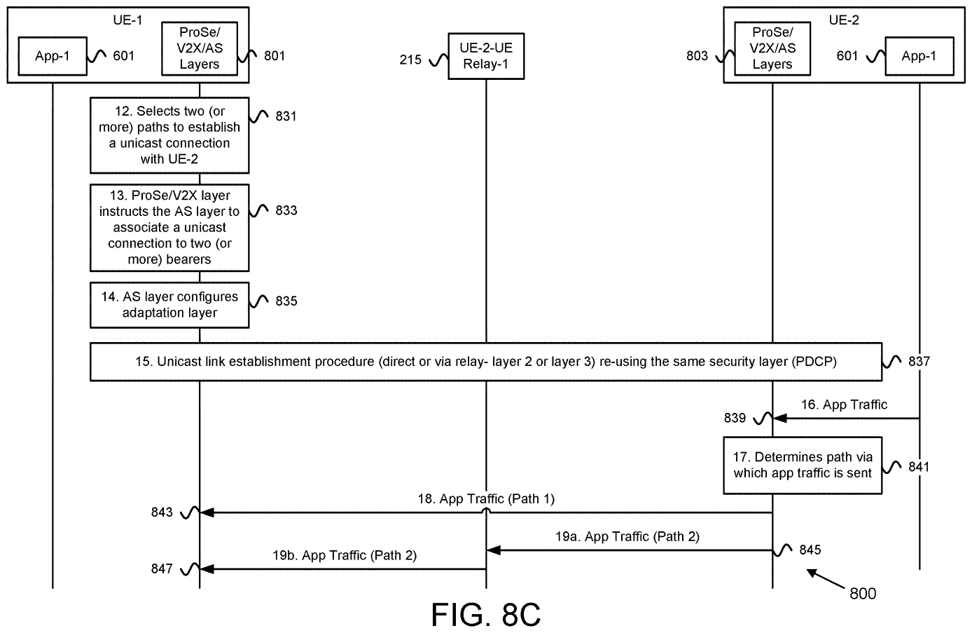

FIGS. 8A-8C depict an example of a second procedure 800 for establishing a multipath unicast connection, according to embodiments of the third solution. The procedure 800 involves the UE-1 205 (i.e., containing one instance of the App-1 601 and a ProSe/V2X layer and AS layer (denoted as combined element “ProSe/V2X/AS layers 801”)), the UE-to-UE Relay-1 215, the UE-to-UE Relay-2, and the UE-2 210 (i.e., containing another instance of the App-1 601 and a ProSe/V2X layer and AS layer (denoted as combined element “ProSe/V2X/AS layers 803”)).

Beginning at FIG. 8A, at Step 1a the ProSe/V2X layer of UE-1 205 receives a request from the App-1 601 to send a SL data packet (see block 805). In certain embodiments, the App-1 601 may include a multipath connection indicator in the request sent to the ProSe/V2X layer of UE-1 205.

At Step 1b, the ProSe/V2X layer at UE-1 205 determines that a multipath connection required, e.g., based on configuration information/or information from higher layers (see block 807).

At Step 2, the UE-1 205 sends a Direct Communication Request message (see messaging 809). As depicted, the Direct Communication Request message is sent directly to UE-2 210 (i.e., Sidelink Path #1) and is relayed by one or more UE-to-UE Relays 215, 220 (e.g., Sidelink Paths #2 and #3). As discussed above with reference to FIGS. 6A-6C, the UE-1 205 includes in the request additional application layer information (i.e., “App layer info”) and a ProSe/V2X identifier or a V2X service type. Based on the multipath requirement determined in Step 1, the UE-1 205 also includes as metadata the L2 identity of UE-1 205 (or another identifier to identify the multipath connection).

At Step 3a, the UE-to-UE Relay-1 215 relays the Direct Communication Request message (if received) to the UE-2 210 (see messaging 811). Here, the UE-to-UE Relay-1 215 includes its own L2 identifier as source L2 ID in the forwarded Direct Communication Request message.

At Step 3b, the UE-to-UE Relay-2 relays the Direct Communication Request message (if received) to the UE-2 210 (see messaging 813). Here, the UE-to-UE Relay-2 includes its own L2 identifier as source L2 ID in the forwarded Direct Communication Request message.

At Step 4, the UE-2 210 determines that it has received multiple Direct Communication Request messages (i.e., via multiple paths) and determines whether it interested in establishing a unicast link (see block 815). The UE-2 210 identifies (i.e., by inspecting the metadata information) that the multiple Direct Communication Request messages are sent from the same UE (i.e., UE-1 205) and contains the same information.

Continuing on FIG. 8B, at Step 5, based on configuration the UE-2 210 determines that a multipath connection can be established (see block 817).

At Step 6, the UE-2 210 selects two or more paths to use to establish a unicast (“UC”) multipath connection, according to the principles described herein (see block 819).

At Step 7, the ProSe/V2X layer at UE-2 210 determines, e.g., based on configuration information, that a unicast connection can be established via different paths and instructs the AS layer to setup a split bearer connection (or setup separate bearers) via the selected paths including in the request the PC5 link identifier (see block 821).

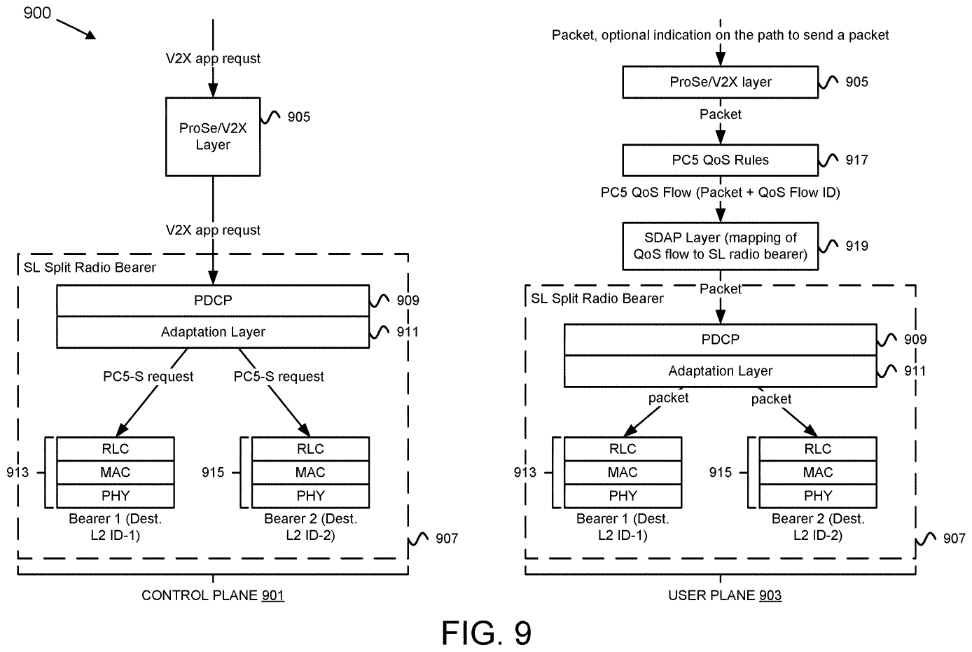

At Step 8, the AS layer at UE-2 210 establishes the separate bearers and allocates a bearer identifier via different paths and configures the adaptation layer (see block 823). The bearers established here are discussed in further detail below, with reference to FIG. 9.

The adaptation layer contains for the PC5 link identifier the Bearer identifier and Source and Target L2 ID for each path. Assuming that the UE-2 210 has established multipath connection where one path is via UE-to-UE Relay-1 215 and the second path is directly to UE-2 210, the adaptation layer includes the following information:
PC5 link identifier of unicast link and corresponding radio bearer ID
   Physical Sidelink bearer 1
      Identifier of physical bearer (e.g., Logical Channel ID 1)
      Source L2 ID (i.e., UE-2 L2 ID) and Target L2 ID (i.e., UE Relay-1 L2 ID) of Link 1
   Physical Sidelink bearer 2
      Identifier of physical bearer (e.g., Logical Channel ID 2)
      Source L2 ID (i.e., UE-2 L2 ID) and Target L2 ID (i.e., UE-1 L2 ID) of Link 2

At Step 9, the UE-2 210 responds to the unicast requests by sending a Direct Communication Response message via a Relay UE (see messaging 825), where the Direct Communication Response message includes the UE-2 L2 ID as source L2 ID, additional App layer info, and a ProSe/V2X or a V2X service type. The UE-2 210 includes as destination L2 ID the destination endpoint based on the path selected. Based on the multipath requirement, the UE-2 210 also includes as metadata the L2 identity of the UE-2 210 (or another identifier to identify the multipath connection).

At Step 10, the UE-to-UE Relay-1 215 forwards the Direct Communication Response message to the UE-1 205 (see messaging 827).

At Step 11, the UE-2 210 responds to the unicast requests by sending a Direct Communication Response message directly to the UE-1 205 (see messaging 829), where the Direct Communication Response message includes the UE-2 L2 ID as source L2 ID, additional App layer info, and a ProSe/V2X identifier or a V2X service type. The UE-2 210 includes as destination L2 ID the destination endpoint based on the path selected (i.e., UE-1 L2 ID for Sidelink Path #1).

According to the third solution, PC5-S messages are sent simultaneously via the different bearers to indicate to UE-1 205 to establish a unicast connection (in a Direct Communication Response message). The Direct Communication Response messages also include as metadata the UE-2 L2 ID. Because the UE-2 210 has selected UE-to-UE Relay-1 215 for one of the paths, at Step 10 the UE-to-UE Relay-1 215 will change the source L2 ID to its own L2 ID, but will also forward the metadata to UE-1 205.

Consequently, the UE-1 205 receives a Direct Communication Response via different paths (different UEs) and identify that the path corresponds to the same Application Layer ID and L2 ID pair. The UE-1 205 identifies that the paths are related based on inspecting the metadata information that contain the L2 ID of UE-2 210.

Continuing on FIG. 8C, at Step 12, the UE-1 205 selects the paths to establish the unicast multipath connection (see block 831). In certain embodiments, the selection is based on UE implementation, e.g., based on configuration received from PLMN/MNO.

At Step 13, the ProSe/V2X layer at UE-1 205 instructs the AS layer to setup a split bearer connection (or setup separate bearers) via the selected paths including in the request the PC5 link identifier (see block 833). Here, the UE-1 205 locally stores information on how the two paths are associated to the same unicast link. In some embodiments, a unicast link is identified by a PC5 link identifier which is associated with a unicast link profile, as described above. To support a multipath unicast link, the unicast link profile may additionally include a Multipath Link ID and/or information on the individual paths/links comprising the multipath unicast link.

At Step 14, the AS layer at UE-1 205 establishes the separate bearers and allocates a bearer identifier via different paths and configures the adaptation layer (see block 835). Again, the bearers established here are discussed in further detail with reference to FIG. 9.

At Step 15, the UE-1 205 establishes the unicast link connection via multiple paths (see block 837). For each Path/Link of the multipath unicast link, the security and QoS negotiation steps may be as described above with reference to FIGS. 3 and 4, and/or as described in 3GPP TS 23.287 with the following difference:
During security negotiation, each UE associates one PDCP connection for the multipath unicast connection that is used for exchanging control plane and user plane signaling via both paths. However, the security and QoS negotiation signaling is carried out only via one path. Which path selected is up to UE implementation. After the unicast link is established, the AS layer at each UE allocates the same QoS to both physical radio bearers according to the QoS negotiated during the unicast link establishment procedure.

At Step 16, the ProSe/V2X layer at UE-2 210 receives application traffic (i.e., one or more packets) from the App-1 601 (see messaging 839).

At Step 17, the ProSe/V2X layer at UE-2 210 determines how to route the packet(s) (i.e., which path to use) (see block 841). The ProSe/V2X layer may indicate to the AS layer via which path to send the application traffic. In one embodiment, the ProSe/V2X layer determines based on configuration or based on instructions from the application layer. In an alternative embodiment, the AS layer may determine via which sidelink bearer to send application traffic.

At Step 18, based on the selected multipath routing scheme, the UE-2 210 may send the application traffic (i.e., one or more packets) directly to the UE-1 205 via Sidelink Path #1 (see messaging 843).

At Step 19a, based on the selected multipath routing scheme, the UE-2 210 may send the application traffic (i.e., one or more packets) to the UE-to-UE Relay-1 215 via Sidelink Path #2 (see messaging 845).

At Step 19b, the UE-to-UE Relay-1 215 forwards the application traffic to the UE-1 205 via Sidelink Path #2 (see messaging 847).

FIG. 9 depicts an example of a multipath unicast link 900, according to embodiments of the first solution, where a ProSe/V2X layer 905 maintains an association of a unicast link to two (or more) sidelink radio bearers (e.g., for control plane 901 and user plane 903). The ProSe/V2X layer 905 may be one embodiment of the ProSe/V2X layer 530, and/or the ProSe/V2X layer of FIG. 8A-8C. The multipath unicast link 900 may be established according to the procedure 800, described above.

It is assumed that a UE has one logical unicast link that contains two independent unicast link connections via different paths. That is, each UE has independent security association via each unicast path. At the control plane 901, the ProSe/V2X layer 905 receives a request from a V2X Application and sends PC5-S signaling to a mapped SL Split Radio Bearer 907.

The mapped SL split radio bearer 907 includes a single PDCP layer 909 and an adaptation layer 911 is located between the PDCP and RLC layer to support the split bearer operation. While the SL split radio bearer 907 maintains a single logical bearer for the multipath unicast link, separate physical bearers are maintained via different RLC/MAC/PHY connections. The adaptation layer 911 sends PC5-S signaling to a first physical radio bearer (denoted “Bearer-1”) 913 and/or a second physical radio bearer (denoted “Bearer-2”) 915, based on the multipath routing scheme. Note that the Bearer-1 913 corresponds to a first destination L2 ID (denoted “Dest. L2 ID-1”), while the Bearer-2 915 corresponds to a second destination L2 ID (denoted “Dest. L2 ID-2”).

At the user plane 903, the ProSe/V2X layer 905 receives a data packet, which may optionally include an indication on which path the packet is to be sent. The ProSe/V2X layer 905 applies PC5 QoS rules 917 to the packet and maps the packet to a PC5 QoS Flow. The ProSe/V2X layer 905 passes the packet and associated QoS Flow ID to the SDAP layer 919. Note the SDAP layer 919 may be an embodiment of the RRC/SDAP layers 525.

The SDAP layer 919 maps the QoS Flow to a SL Radio Bearer and sends the packet to the mapped SL Split Radio Bearer. Where the packet is to be duplicated, the packet duplication may occur at the adaptation layer 911.

As described above, the AS layer maintains a single PDCP connection and a single logical bearer for the multipath unicast link and separate physical bearers via different RLC/MAC/PHY connections.

As discussed above, the adaptation layer includes information on the mapping of each link in the unicast profile of the unicast link to a sidelink radio bearer as follows:
PC5 link identified by a PC5 link identifier that is mapped to a logical bearer with specific bearer identifier
Link 1:
   Logical Channel ID or new identifier to identify the physical sidelink radio bearer
   Source and Target Layer-2 ID
Link 2:
   Logical Channel ID or new identifier to identify the physical sidelink radio bearer Source and Target Layer-2 ID

When the AS layer manages the radio bearer identified by its bearer identifier the AS layer manages simultaneously the physical sidelink bearers. For example, the same Discontinuous Reception (“DRX”) is used.

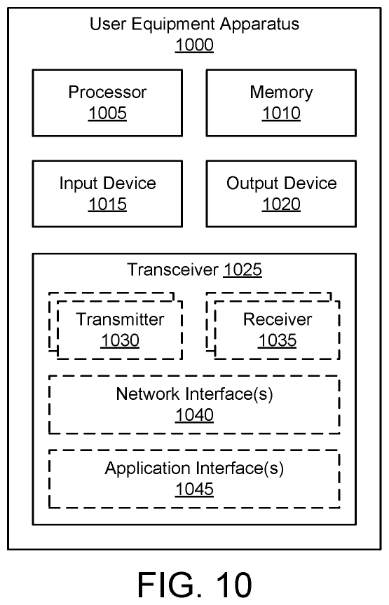

FIG. 10 depicts a user equipment apparatus 1000 that may be used for establishing a multipath unicast link, according to embodiments of the disclosure. In various embodiments, the user equipment apparatus 1000 is used to implement one or more of the solutions described above. The user equipment apparatus 1000 may be one embodiment of the remote unit 105 and/or the UE 205, described above. Furthermore, the user equipment apparatus 1000 may include a processor 1005, a memory 1010, an input device 1015, an output device 1020, and a transceiver 1025.

In some embodiments, the input device 1015 and the output device 1020 are combined into a single device, such as a touchscreen. In certain embodiments, the user equipment apparatus 1000 may not include any input device 1015 and/or output device 1020. In various embodiments, the user equipment apparatus 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. In some embodiments, the transceiver 1025 communicates with one or more cells (or wireless coverage areas) supported by one or more base units 121. In various embodiments, the transceiver 1025 is operable on unlicensed spectrum. Moreover, the transceiver 1025 may include multiple UE panels supporting one or more beams. Additionally, the transceiver 1025 may support at least one network interface 1040 and/or application interface 1045. The application interface(s) 1045 may support one or more APIs. The network interface(s) 1040 may support 3GPP reference points, such as Uu, N1, PC5, etc. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025.

In various embodiments, the processor 1005 controls the user equipment apparatus 1000 to implement the above described UE behaviors. In certain embodiments, the processor 1005 may include an application processor (also known as “main processor”) which manages application-domain and operating system (“OS”) functions and a baseband processor (also known as “baseband radio processor”) which manages radio functions.

In various embodiments, the processor 1005 controls the apparatus 1000 to implement the above UE behavior. In some embodiments, the transceiver 1025 receives (e.g., via a sidelink interface) a first request for establishing a sidelink unicast connection via a first path (e.g., from a first Relay UE), where the first request includes a first identifier of a first requestor (e.g., as metadata in the first request). Moreover, the transceiver 1025 receives a second request for establishing the sidelink unicast connection via a second path (e.g., from a second Relay UE or directly from the source UE), where the second request includes the first identifier (e.g., as metadata in the second request).

The processor 1005 determines that a multipath unicast connection is allowed to be established via the first and second paths and allocates a link identifier (i.e., a PC5 link identifier) for the multipath unicast connection. The processor 1005 also establishes a plurality of physical radio bearers and associates each physical bearer with the link identifier. Here, each bearer corresponds to a path of the multipath unicast connection. In some embodiments, the transceiver 1025 further sends a response via the first and second paths, where the response includes a unicast establishment response including a L2 identifier of the receiver UE (e.g., as metadata in the unicast establishment response).

In some embodiments, the processor 1005 further routes a packet via the established multipath unicast connection, where routing the packet comprises duplicating the packet and sending copies of the packet via each of the first and second paths. In such embodiments, the packet duplication may occur at any of: a Proximity Services (“ProSe”) layer, a Vehicle-to-Everything (“V2X”) layer, and an adaptation layer.

In some embodiments, associating each physical bearer with the first link identifier includes locally storing a unicast link profile for the multipath unicast link. In such embodiments, the unicast link profile contains the first identifier of the first requestor, source and target L2 identifiers corresponding to the first path, and source and target L2 identifiers corresponding to the second path. In certain embodiments, the unicast link profile further contains physical bearer identifiers for each physical bearer.

In some embodiments, establishing the plurality of physical radio bearers comprises sending a third request to the lower layers (e.g., Access Stratum layer) to establish separate bearers (or split bearer) via the first and second paths. In such embodiments, the third request includes the PC5 link identifier and the source and target L2 identifiers of the first and the second path. In certain embodiments, a single PDCP layer is associated with both the first path and the second path. In certain embodiments, each path of the multipath unicast link has an independent PDCP layer. While the above embodiments describe a first path and a second path, in other embodiments the multipath unicast link may include three or more paths. In such embodiments, the different paths may have different source and target L2 identifiers. In certain embodiments, the single PDCP layer is associated with all paths of the multipath unicast link.

In some embodiments, the transceiver 1025 further receives configuration information from a mobile communication network. In such embodiments, the determination that the multipath connection is allowed to be established is determined based on the configuration information, where the configuration information indicated one or more services (e.g., defined as V2X service types and/or ProSe/V2X services) for which a multipath connection can be established. In certain embodiments, the configuration information indicates that a multipath connection is to be established when a required reliability (e.g., from a corresponding PQI) exceeds a threshold. In certain embodiments, the configuration information indicates that a multipath connection is to be established when indicated by a QoS requirement.

In some embodiments, the processor 1005 determines that the first path and second path are associated with the same sidelink unicast connection request from the first requestor based on the first identifier of the first requestor (e.g., contained in the metadata) and further based on one or more source and target application layer identifiers associated with the first requestor and the receiver UE. In some embodiments, the first identifier is contained in metadata of the first and second requests, said metadata different than Source L2 identifiers for the first and second paths.

The memory 1010, in one embodiment, is a computer readable storage medium. In some embodiments, the memory 1010 includes volatile computer storage media. For example, the memory 1010 may include a RAM, including dynamic RAM (“DRAM”), synchronous dynamic RAM (“SDRAM”), and/or static RAM (“SRAM”). In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data related to establishing a multipath unicast link and/or mobile operation. For example, the memory 1010 may store various parameters, panel/beam configurations, resource assignments, policies, and the like as described above. In certain embodiments, the memory 1010 also stores program code and related data, such as an operating system or other controller algorithms operating on the apparatus 1000.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, is designed to output visual, audible, and/or haptic signals. In some embodiments, the output device 1020 includes an electronically controllable display or display device capable of outputting visual data to a user. For example, the output device 1020 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 1020 may include a wearable display separate from, but communicatively coupled to, the rest of the user equipment apparatus 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all or portions of the output device 1020 may be integrated with the input device 1015. For example, the input device 1015 and output device 1020 may form a touchscreen or similar touch-sensitive display. In other embodiments, the output device 1020 may be located near the input device 1015.

The transceiver 1025 communicates with one or more network functions of a mobile communication network via one or more access networks. The transceiver 1025 operates under the control of the processor 1005 to transmit messages, data, and other signals and also to receive messages, data, and other signals. For example, the processor 1005 may selectively activate the transceiver 1025 (or portions thereof) at particular times in order to send and receive messages.

The transceiver 1025 includes at least transmitter 1030 and at least one receiver 1035. One or more transmitters 1030 may be used to provide UL communication signals to a base unit 121, such as the UL transmissions described herein. Similarly, one or more receivers 1035 may be used to receive DL communication signals from the base unit 121, as described herein. Although only one transmitter 1030 and one receiver 1035 are illustrated, the user equipment apparatus 1000 may have any suitable number of transmitters 1030 and receivers 1035. Further, the transmitter(s) 1030 and the receiver(s) 1035 may be any suitable type of transmitters and receivers. In one embodiment, the transceiver 1025 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1025, transmitters 1030, and receivers 1035 may be implemented as physically separate components that access a shared hardware resource and/or software resource, such as for example, the network interface 1040.

In various embodiments, one or more transmitters 1030 and/or one or more receivers 1035 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 1030 and/or one or more receivers 1035 may be implemented and/or integrated into a multi-chip module. In some embodiments, other components such as the network interface 1040 or other hardware components/circuits may be integrated with any number of transmitters 1030 and/or receivers 1035 into a single chip. In such embodiment, the transmitters 1030 and receivers 1035 may be logically configured as a transceiver 1025 that uses one more common control signals or as modular transmitters 1030 and receivers 1035 implemented in the same hardware chip or in a multi-chip module.

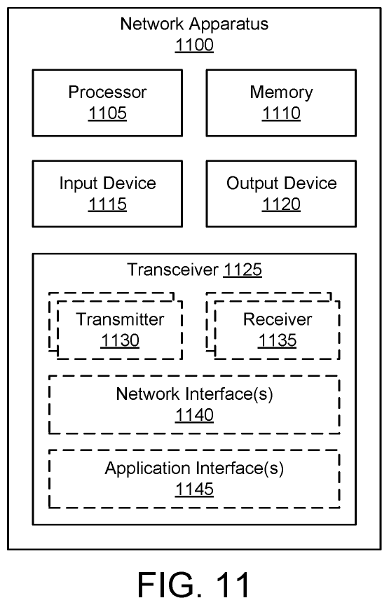

FIG. 11 depicts a network apparatus 1100 that may be used for establishing a multipath unicast link, according to embodiments of the disclosure. In one embodiment, network apparatus 1100 may be one implementation of a RAN entity, such as the base unit 121 described above. Furthermore, the base network apparatus 1100 may include a processor 1105, a memory 1110, an input device 1115, an output device 1120, and a transceiver 1125.

In some embodiments, the input device 1115 and the output device 1120 are combined into a single device, such as a touchscreen. In certain embodiments, the network apparatus 1100 may not include any input device 1115 and/or output device 1120. In various embodiments, the network apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. Here, the transceiver 1125 communicates with one or more remote units 105. Additionally, the transceiver 1125 may support at least one network interface 1140 and/or application interface 1145. The application interface(s) 1145 may support one or more APIs. The network interface(s) 1140 may support 3GPP reference points, such as Uu, N1, N2 and N3. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a CPU, a GPU, an auxiliary processing unit, a FPGA, or similar programmable controller. In some embodiments, the processor 1105 executes instructions stored in the memory 1110 to perform the methods and routines described herein. The processor 1105 is communicatively coupled to the memory 1110, the input device 1115, the output device 1120, and the transceiver 1125.

In various embodiments, the network apparatus 1100 is a RAN node (e.g., gNB) that communicates with one or more UEs, as described herein. In such embodiments, the processor 1105 controls the network apparatus 1100 to perform the above described RAN behaviors. When operating as a RAN node, the processor 1105 may include an application processor (also known as “main processor”) which manages application-domain and operating system (“OS”) functions and a baseband processor (also known as “baseband radio processor”) which manages radio functions.

The memory 1110, in one embodiment, is a computer readable storage medium. In some embodiments, the memory 1110 includes volatile computer storage media. For example, the memory 1110 may include a RAM, including dynamic RAM (“DRAM”), synchronous dynamic RAM (“SDRAM”), and/or static RAM (“SRAM”). In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to establishing a multipath unicast link and/or mobile operation. For example, the memory 1110 may store parameters, configurations, resource assignments, policies, and the like, as described above. In certain embodiments, the memory 1110 also stores program code and related data, such as an operating system or other controller algorithms operating on the apparatus 1100.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, an LCD display, an LED display, an OLED display, a projector, or similar display device capable of outputting images, text, or the like to a user. As another, non-limiting, example, the output device 1120 may include a wearable display separate from, but communicatively coupled to, the rest of the network apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (e.g., a beep or chime). In some embodiments, the output device 1120 includes one or more haptic devices for producing vibrations, motion, or other haptic feedback. In some embodiments, all or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 includes at least transmitter 1130 and at least one receiver 1135. One or more transmitters 1130 may be used to communicate with the UE, as described herein. Similarly, one or more receivers 1135 may be used to communicate with network functions in the PLMN and/or RAN, as described herein. Although only one transmitter 1130 and one receiver 1135 are illustrated, the network apparatus 1100 may have any suitable number of transmitters 1130 and receivers 1135. Further, the transmitter(s) 1130 and the receiver(s) 1135 may be any suitable type of transmitters and receivers.

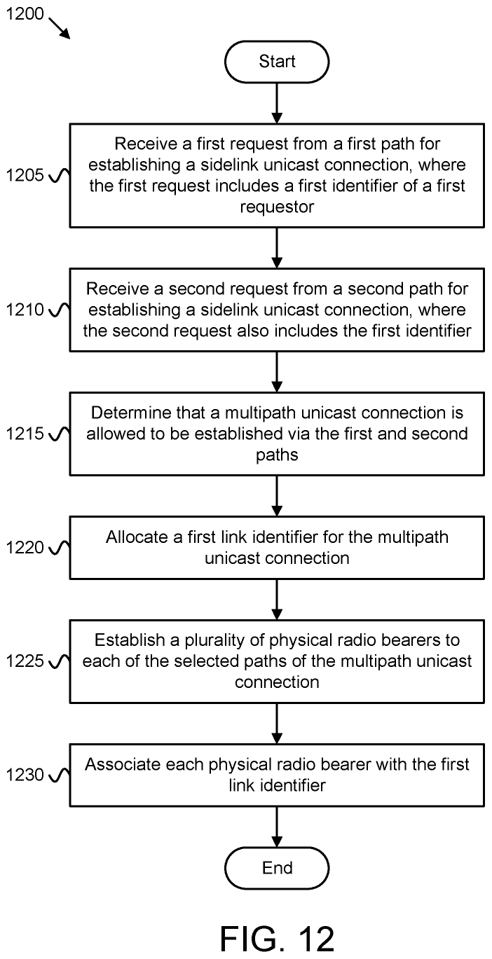

FIG. 12 depicts one embodiment of a method 1200 for establishing a multipath unicast link, according to embodiments of the disclosure. In various embodiments, the method 1200 is performed by a UE device, such as the remote unit 105, the UE-2 210, and/or the user equipment apparatus 1000, described above as described above. In some embodiments, the method 1200 is performed by a processor, such as a microcontroller, a microprocessor, a CPU, a GPU, an auxiliary processing unit, a FPGA, or the like.

The method 1200 begins and receives 1205 a first request from a first path (e.g., from a first Relay UE) for establishing a sidelink unicast connection. Here, the first request includes a first identifier of a first requestor (e.g., as metadata in the first request). The method 1200 includes receiving 1210 a second request from a second path (e.g., from a second Relay UE or directly from the source UE) for establishing a sidelink unicast connection. Here, the second request also includes the first identifier (e.g., as metadata in the second request). The method 1200 includes determining 1215 that a multipath unicast connection is allowed to be established via the first and second paths. The method 1200 includes allocating 1220 a first link identifier for the multipath unicast connection. The method 1200 includes establishing 1225 a plurality of physical radio bearers to each of the selected paths of the multipath unicast connection. The method 1200 includes associating 1230 each physical bearer with the first link identifier. Here, each bearer corresponds to a path of the multipath unicast connection and each bearer is associated with a bearer identifier. The method 1200 ends.

Disclosed herein is a first apparatus for establishing a multipath unicast link, according to embodiments of the disclosure. The first apparatus may be implemented by a UE device, such as the remote unit 105, the UE-2 210, and/or the user equipment apparatus 1000, described above. The first apparatus includes a processor and a transceiver that receives a first request from a first path (e.g., from a first Relay UE) for establishing a sidelink unicast connection and receives a second request from a second path (e.g., from a second Relay UE or directly from the source UE) for establishing a sidelink unicast connection, where the first request includes a first identifier of a first requestor (e.g., as metadata in the first request) and where the second request also includes the first identifier (e.g., as metadata in the second request). The processor determines that a multipath unicast connection is allowed to be established via both the first path and the second path and allocates a link identifier for the multipath unicast connection. The processor also establishes a plurality of physical radio bearers and associates each physical bearer with the link identifier. Here, each bearer corresponds a path of the multipath unicast connection.

In some embodiments, the transceiver further sends a response via both the first path and the second path, where the response includes a unicast establishment response including a L2 identifier of the receiver UE (e.g., as metadata in the unicast establishment response). In some embodiments, the processor further routes a packet via the established multipath unicast connection, where routing the packet comprises duplicating the packet and sending copies of the packet via each of both the first path and the second path. In such embodiments, the packet duplication may occur at any of: a Proximity Services (“ProSe”) layer, a Vehicle-to-Everything (“V2X”) layer, and an adaptation layer.

In some embodiments, associating each physical bearer with the first link identifier includes locally storing a unicast link profile for the multipath unicast link. In such embodiments, the unicast link profile contains the first identifier of the first requestor, a source L2 identifier corresponding to the first path, a target L2 identifiers corresponding to the first path, a source L2 identifier corresponding to the second path, and a target L2 identifier corresponding to the second path. In certain embodiments, the unicast link profile further contains physical bearer identifiers for each physical bearer.

In some embodiments, establishing the plurality of physical radio bearers comprises sending a third request to the lower layers (e.g., Access Stratum layer) to establish separate bearers via both the first path and the second path. In such embodiments, the third request includes the PC5 link identifier, a source L2 identifier corresponding to the first path, a target L2 identifiers corresponding to the first path, a source L2 identifier corresponding to the second path, and a target L2 identifier corresponding to the second path. In certain embodiments, a single PDCP layer is associated with each path of the multipath unicast link. In certain embodiments, each path of the multipath unicast link has an independent PDCP layer.

In some embodiments, the transceiver further receives configuration information from a mobile communication network. In such embodiments, the determination that the multipath connection is allowed to be established is determined based on the configuration information, where the configuration information indicated one or more services (e.g., defined as V2X service types and/or ProSe/V2X services) for which a multipath connection can be established. In certain embodiments, the configuration information indicates that a multipath connection is to be established when a required reliability (e.g., from a corresponding PQI) exceeds a threshold. In certain embodiments, the configuration information indicates that a multipath connection is to be established when indicated by a QoS requirement.

In some embodiments, the processor determines that the first path and second path are associated with the same sidelink unicast connection request from the first requestor based on the first identifier of the first requestor (e.g., contained in the metadata) and further based on one or more source and target application layer identifiers associated to the first requestor and the receiver UE. In some embodiments, the first identifier is contained in metadata of the first and second requests, said metadata different than source L2 identifiers for both the first path and the second path.

Disclosed herein is a first method for establishing a multipath unicast link, according to embodiments of the disclosure. The first method may be performed by a UE device, such as the remote unit 105, the UE-2 210, and/or the user equipment apparatus 1000, described above. The first method includes receiving a first request from a first path (e.g., from a first Relay UE) for establishing a sidelink unicast connection and receiving a second request from a second path (e.g., from a second Relay UE or directly from the source UE) for establishing a sidelink unicast connection. Here, the first request includes a first identifier of a first requestor (e.g., as metadata in the first request) and the second request also includes the first identifier (e.g., as metadata in the second request). The first method includes determining that a multipath unicast connection is allowed to be established via both the first path and the second path and allocating a first link identifier for the multipath unicast connection. The first method includes establishing a plurality of physical radio bearers and associating each physical bearer with the first link identifier. Here, each bearer corresponds to a path of the multipath unicast connection and each bearer is associated with a bearer identifier.

In some embodiments, the first method includes sending a response via both the first path and the second path, where the response includes a unicast establishment response including a L2 identifier of the receiver UE (e.g., as metadata in the unicast establishment response). In some embodiments, the first method includes routing a packet via the established multipath unicast connection, where routing the packet comprises duplicating the packet and sending copies of the packet via each of both the first path and the second path. In such embodiments, the packet duplication may occur at any of: a Proximity Services (“ProSe”) layer, a Vehicle-to-Everything (“V2X”) layer, and an adaptation layer.

In some embodiments, associating each physical bearer with the first link identifier includes locally storing a unicast link profile for the multipath unicast link. In such embodiments, the unicast link profile contains the first identifier of the first requestor, a source L2 identifier corresponding to the first path, a target L2 identifiers corresponding to the first path, a source L2 identifier corresponding to the second path, and a target L2 identifier corresponding to the second path. In certain embodiments, the unicast link profile further contains physical bearer identifiers for each physical bearer.

In some embodiments, establishing the plurality of physical radio bearers comprises sending a third request to the lower layers (e.g., Access Stratum layer) to establish separate bearers via both the first path and the second path. In such embodiments, the third request includes the PC5 link identifier, a source L2 identifier corresponding to the first path, a target L2 identifiers corresponding to the first path, a source L2 identifier corresponding to the second path, and a target L2 identifier corresponding to the second path. In certain embodiments, a single PDCP layer is associated with each path of the multipath unicast link. In certain embodiments, each path of the multipath unicast link has an independent PDCP layer.

In some embodiments, the first method includes receiving configuration information from a mobile communication network. In such embodiments, the determination that the multipath connection is allowed to be established is determined based on the configuration information, where the configuration information indicated one or more services (e.g., defined as V2X service types and/or ProSe/V2X services) for which a multipath connection can be established. In certain embodiments, the configuration information indicates that a multipath connection is to be established when a required reliability (e.g., from a corresponding PQI) exceeds a threshold. In certain embodiments, the configuration information indicates that a multipath connection is to be established when indicated by a QoS requirement.

In some embodiments, the first method includes determining that the first path and second path are associated with the same sidelink unicast connection request from the first requestor based on the first identifier of the first requestor (e.g., contained in the metadata) and further based on one or more source and target application layer identifiers associated to the first requestor and the receiver UE. In some embodiments, the first identifier is contained in metadata of the first and second requests, said metadata different than source L2 identifiers for both the first path and the second path.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A User Equipment (“UE”) apparatus comprising:
a transceiver that:
receives a first request from a first path for establishing a sidelink unicast connection wherein the request includes a first identifier of a first requestor; and
receives a second request from a second path for establishing a sidelink unicast connection wherein the request includes the first identifier; and
a processor that:
determines that a multipath unicast connection is allowed to be established via the first and second paths;
allocates a link identifier for the multipath unicast connection;
establishes a plurality of physical radio bearers, each bearer corresponding a path of the multipath unicast connection; and
associates each physical bearer with the link identifier.

2. The apparatus of claim 1, wherein the processor routes a packet via the multipath unicast connection, wherein routing the packet comprises duplicating the packet and sending copies of the packet via each of the first and second paths, wherein the packet duplication occurs at one of: a Proximity Services (“ProSe”) layer, a Vehicle-to-Everything (“V2X”) layer, and an adaptation layer.

3. The apparatus of claim 1, wherein associating each physical bearer with the link identifier comprising locally storing a unicast link profile for the multipath unicast connection, wherein the unicast link profile comprises the first identifier of the first requestor, a source Layer-2 identifier corresponding to the first path, a target Layer-2 identifiers corresponding to the first path, a source Layer-2 identifier corresponding to the second path, a target Layer-2 identifier corresponding to the second path, and physical bearer identifiers for each physical bearer.

4. The apparatus of claim 1, wherein associating each physical bearer with the link identifier comprising locally storing a unicast link profile for the multipath unicast connection, wherein the unicast link profile comprises the first identifier of the first requestor, a source Layer-2 identifier corresponding to the first path, a target Layer-2 identifiers corresponding to the first path, a source Layer-2 identifier corresponding to the second path, and a target Layer-2 identifier corresponding to the second path.

5. The apparatus of claim 1, wherein establishing the plurality of physical radio bearers comprises sending a third request to lower layers to establish separate bearers via the first and second paths, wherein the third request includes the link identifier, a source Layer-2 identifier corresponding to the first path, a target Layer-2 identifiers corresponding to the first path, a source Layer-2 identifier corresponding to the second path, and a target Layer-2 identifier corresponding to the second path.

6. The apparatus of claim 5, wherein a single PDCP layer is associated with each path of the multipath unicast connection.

7. The apparatus of claim 5, wherein each path of the multipath unicast connection has an independent PDCP layer.

8. The apparatus of claim 1, wherein the transceiver further sends a response via the first and second paths, wherein the response includes a unicast establishment response including a Layer-2 identifier of the receiver UE.

9. The apparatus of claim 1, wherein the transceiver further receives configuration information from a mobile communication network, wherein the determination that the multipath connection is allowed to be established is determined based on the configuration information, wherein the configuration information indicated one or more services for which a multipath connection can be established.

10. The apparatus of claim 9, wherein the configuration information indicates that a multipath connection is to be established when a required reliability exceeds a threshold.

11. The apparatus of claim 9, wherein the configuration information indicates that a multipath connection is to be established when indicated by a QoS requirement.

12. The apparatus of claim 1, wherein the processor further determines that the first path and second path are associated with the same sidelink unicast connection request from the first requestor based on the first identifier of the first requestor and further based on one or more source and target application layer identifiers associated with the first requestor and a receiver UE.

13. The apparatus of claim 1, wherein the first identifier is contained in metadata of the first and second requests, said metadata different than Source Layer-2 identifiers for the first and second paths.

14. A method of a User Equipment (“UE”), the method comprising:
receiving a first request from a first path for establishing a sidelink unicast connection wherein the request includes a first identifier of a first requestor;
receiving a second request from a second path for establishing a sidelink unicast connection wherein the request includes the first identifier;
determining that a multipath unicast connection is allowed to be established via the first and second paths;
allocating a first link identifier for the multipath unicast connection;
establishing a plurality of physical radio bearers, each bearer associated with a bearer identifier, wherein each bearer corresponds to a path of the multipath unicast connection; and
associating each physical bearer with the first link identifier.

15. The method of claim 14, wherein associating each physical bearer with the first link identifier comprising locally storing a unicast link profile for the multipath unicast connection, wherein the unicast link profile comprises the first identifier of the first requestor, source and target Layer-2 identifiers corresponding to the first path, and source and target Layer-2 identifiers corresponding to the second path.
